(19) United States
(12) Patent Application Publication
(10) Pub. No.: US 2006/0103606 A1
(43) Pub. Date: May 18, 2006

(54) Organic electroluminescence display device

(75) Inventors: Seong Jun Ahn, Kyoungki-do (KR); Chang Soo Pyon, Seoul (KR)

Correspondence Address: SEYFARTH SHAW LLP, 55 E. MONROE STREET, SUITE 4200, CHICAGO, IL, 60603-5803, US

(73) Assignee: Boe Hydis Technology Co., Ltd.

(21) Appl. No.: 11/243,591

(22) Filed: Oct. 5, 2005

(30) Foreign Application Priority Data
Nov. 12, 2004 (KR) 10-2004-0092705

(51) Int. Cl. G09G 3/30

(52) U.S. Cl. 345/76

(57) ABSTRACT

Disclosed is an organic electroluminescence display device which can prevent the degradation of image quality and the property deterioration of a transistor provided in each pixel. The organic electroluminescence display device comprises data lines, gate lines, pixels and a power line, wherein, each of the pixels comprising: a first switching means having a first terminal, a second terminal, and a third terminal through which the data signal is outputted; a capacitor connected to the first switching means to be charged with the data signal; a second switching means for connecting the capacitor to the power line; a third switching means for connecting the capacitor to a ground terminal; a driving means having a first terminal, a second terminal, and a third terminal through which current from the power line is outputted; and an organic light emitting means connected to the driving means to emit light.

### BACKGROUND OF THE INVENTION

1. Field of the Invention

The present invention relates to an organic electroluminescence display device, and more particularly to an organic electroluminescence display device which can prevent the degradation of image quality and the property deterioration of a transistor provided in each pixel.

2. Description of the Prior Art

Recently, liquid crystal display devices have been developed to be used as a replacement for cathode ray tubes (CRTs) and the usage thereof has gradually increased. Since the liquid crystal display device is a device which cannot emit light for itself, it requires a separate light source, thereby causing high power consumption and having a limitation in reducing the thickness thereof. In addition, since the liquid crystal display device obtains image signals through the reaction of liquid crystal, the liquid crystal display device has a limitation in displaying high-speed moving pictures due to the time required for response of the liquid crystal. There also exists a limitation with the viewing angle. As a display device for replacing such a liquid crystal display device, an organic electroluminescence display device has being developed. This organic electroluminescence display device uses a light emission phenomenon occurring when an electric field is applied to a specific organic or polymer substance.

Hereinafter, an organic electroluminescence display device will be described with reference to FIG. 1.

FIG. 1 is a block diagram schematically illustrating an organic electroluminescence display device.

The organic electroluminescence display device includes a panel 11, a gate driver 12 connected to the panel 11, a data driver 13 connected to the panel 11, a timing control unit 14 for controlling the drivers 12 and 13. The panel 11 includes a plurality of gate lines G₁, G₂, . . . , Gₘ₋₁ and Gₘ aligned parallel, and a plurality of data lines D₁, D₂, . . . , Dₙ₋₁ and Dₙ intersecting the gate lines G₁, G₂, . . . , Gₘ₋₁ and Gₘ. Each region surrounded by the gate lines G₁, G₂, . . . , Gₘ₋₁ and Gₘ and data lines D₁, D₂, . . . , Dₙ₋₁ and Dₙ, which are aligned in a matrix pattern, forms a unit pixel.

FIG. 2 is a circuit diagram illustrating a pixel in the conventional organic electroluminescence display device.

According to the conventional organic electroluminescence display device, each pixel includes a switching transistor T1, a capacitor C, a driving transistor T2 and an organic light emitting diode OLED.

A drain terminal of the switching transistor T1 is connected to a data line D and a gate terminal thereof is connected to a gate line G. The switching transistor T1 is turned on/off by a gate signal transmitted to the gate line G. When the switching transistor T1 is turned on, the switching transistor T1 transmits a data signal, which has been transmitted from the data line D, to the capacitor C and the driving transistor T2. The capacitor C is connected to a power line P carrying power applied from an exterior and is charged with a data signal. A gate terminal of the driving transistor T2 is connected to both a source terminal of the switching transistor T1 and the capacitor C, and a drain terminal of the driving transistor T2 is connected to the power line P. The driving transistor T2 is turned on/off by a data signal applied from the switching transistor T1 and by a data signal with which the capacitor C is charged. When the driving transistor T2 is turned on by the data signal, the driving transistor T2 transmits electric current flowing through the power line P to the organic light emitting diode OLED after controlling the amount of the electric current. As a result, the organic light emitting diode OLED emits light, the intensity of which is proportional to the amount of the electric current transmitted to the organic light emitting diode OLED.

According to the above-mentioned conventional organic electroluminescence display device, when a pixel is turned on by a gate signal, the driving transistor T2 provided in the pixel is always turned on, thereby continuously applying electric current to the organic light emitting diode OLED. Accordingly, the property of the driving transistor T2 is deteriorated to change the threshold voltage Vth of the driving transistor T2. Such a change in the threshold voltage also changes the output electric current of the driving transistor T2, so that the uniformity of light emitted from the organic light emitting diode OLED deteriorates and, thus, the quality of the image deteriorates. Consequently, the life span of the organic electroluminescence display device may be shortened. Also, according to the conventional organic electroluminescence display device, owing to high-speed response, the user perceives the mean luminosity between those of successive first and second frames, so that the display screen may be perceived as blurred.

### SUMMARY OF THE INVENTION

Accordingly, the present invention has been made to solve the above-mentioned problems occurring in the conventional organic electroluminescence display device, and an object of the present invention is to provide an organic electroluminescence display device which can prevent the property deterioration of a driving transistor provided in each pixel and can improve image quality.

In order to accomplish this object, there is provided an organic electroluminescence display device comprising: a plurality of data lines for transmitting a data signal; a plurality of gate lines intersecting the data lines and transmitting a gate signal; a plurality of pixels formed by the data lines and the gate lines; and a power line for transmitting power from an exterior, wherein, each of the pixels comprising: a first switching means having a first terminal connected to one of the data lines, a second terminal connected to one of the gate lines, and a third terminal through which the data signal is outputted; a capacitor connected to the third terminal of the first switching means to be charged with the data signal; a second switching means for connecting the capacitor to the power line; a third switching means for connecting the capacitor to a ground terminal; a driving means having a first terminal connected to the power line, a second terminal connected to the third terminal of the first switching means, and a third terminal through which electric current from the power line is outputted; and an organic light emitting means connected to the third terminal of the driving means, the organic light emitting means emitting light, intensity of the light being proportional to amount of the electric current outputted through the third terminal of the driving means.

In accordance with another aspect of the present invention, the first switching means is turned on/off by the gate signal, and the second and the third switching means are turned on/off by a first and a second control signal.

In accordance with still another aspect of the present invention, the second switching means is turned on at a time point when the first switching means is turned on to initiate a first frame, and is turned off a predetermined time interval before the first frame ends.

In accordance with still another aspect of the present invention, the third switching means is turned on at a time point when the second switching means is turned off, and is turned off at a time point when the first frame ends.

In accordance with still another aspect of the present invention, the capacitor is charged with the data signal during a period in which the second switching means is turned on, and is discharged with the data signal during a period in which the third switching means is turned on.

In accordance with still another aspect of the present invention, the driving means controls an amount of the electric current transmitted to the organic light emitting means, according to the data signal with which the capacitor is charged.

In accordance with still another aspect of the present invention, the driving means is turned off at a period when the third switching means is turn on.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating an organic electroluminescence display device;

FIG. 2 is a circuit diagram illustrating a pixel in the conventional organic electroluminescence display device;

FIG. 3 is a circuit diagram illustrating a pixel in an organic electroluminescence display device according to an embodiment of the present invention; and

FIG. 4 is a waveform diagram illustrating the operation of the organic electroluminescence display device according to an embodiment of the present invention.

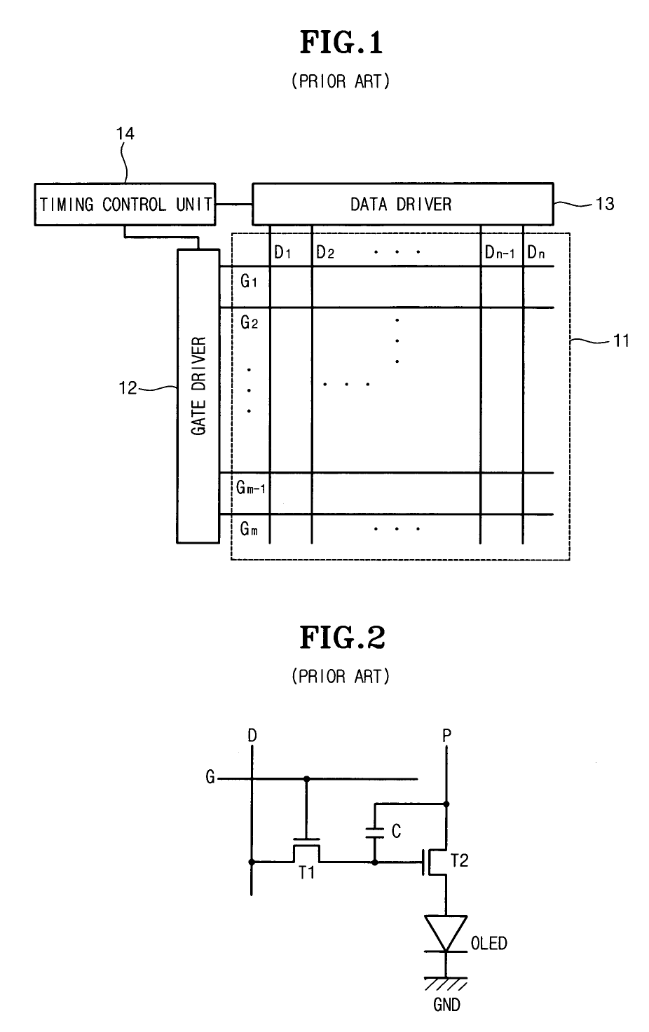

### DETAILED DESCRIPTION OF THE PREFERRED EMBODIMENTS

Hereinafter, a preferred embodiment of the present invention will be described with reference to the accompanying drawings. In the following description and drawings, the same reference numerals are used to designate the same or similar components, and so repetition of the description on the same or similar components will be omitted.

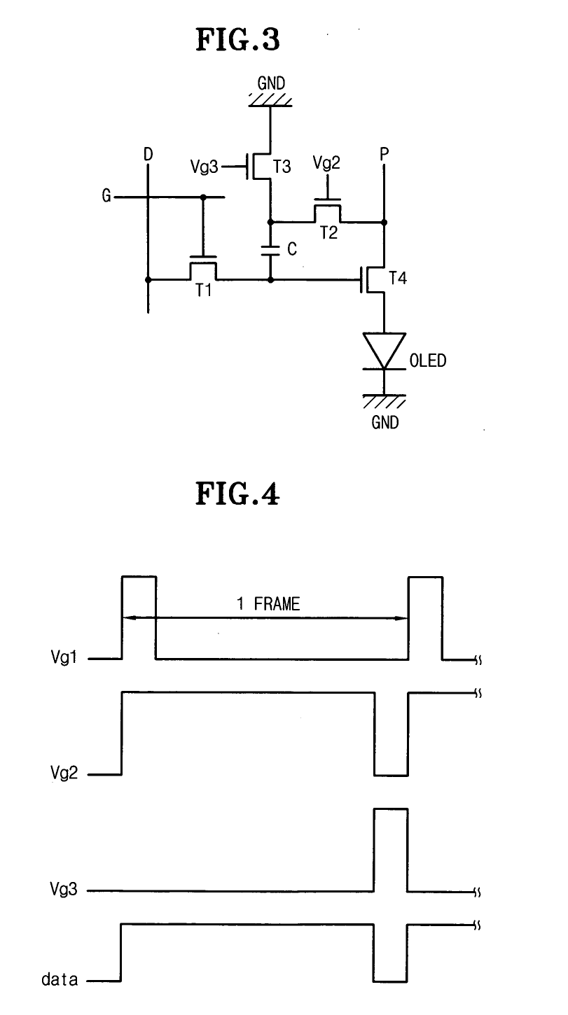

FIG. 3 is a circuit diagram illustrating a pixel in an organic electroluminescence display device according to an embodiment of the present invention.

According to an embodiment of the present invention, each pixel of the organic electroluminescence display device includes switching transistors T1, T2 and T3, a capacitor C, a driving transistor T4, and an organic light emitting diode OLED. Herein, each of the switching transistors T1, T2 and T3 may include an MOS transistor or a thin-film transistor.

A drain terminal of a first switching transistor T1 is connected to a data line D, and a gate terminal thereof is connected to a gate line G. The first switching transistor T1 is turned on/off by a gate signal transmitted through the gate line G. When the first switching transistor T1 is turned on, the first switching transistor T1 transmits a data signal carried through the data line D to both the capacitor C and the driving transistor T4. The second switching transistor T2 is connected between the capacitor C and a power line P carrying power applied from an exterior, and is turned on/off by a first control signal Vg2. The third switching transistor T3 connects the capacitor C to a ground terminal GND, and is turned on/off by a second control signal Vg3.

The capacitor C is charged with a data signal applied through the first switching transistor T1. A gate terminal of the driving transistor T4 is connected to both a source terminal of the first switching transistor T1 and the capacitor C, and a drain terminal of the driving transistor T4 is connected to the power line P. The driving transistor T4 is turned on/off by a data signal applied from the first switching transistor T1 and a data signal with which the capacitor C is charged. When the driving transistor T4 is turned on by the data signal, the driving transistor T4 transmits electric current flowing through the power line P to the organic light emitting diode OLED after controlling the amount of the electric current. As a result, the organic light emitting diode OLED emits light, the intensity of which is proportional to the amount of the electric current transmitted to the organic light emitting diode OLED.

Hereinafter, the operation of the organic electroluminescence display device according to an embodiment of the present invention will be described with reference to FIG. 4.

FIG. 4 is a waveform diagram illustrating operation waveforms of the organic electroluminescence display device according to an embodiment of the present invention.

In the organic electroluminescence display device according to an embodiment of the present invention, when a gate signal Vg1 of a high level is applied to the first switching transistor T1 provided in each pixel, the first switching transistor T1 is turned on, so that the corresponding pixel is turned on to initiate a first frame. In addition, when the first switching transistor T1 is turned on, a data signal transmitted through the data line is applied to both the capacitor C and the driving transistor T4. In this case, while the gate signal Vg1 is being applied to the first switching transistor T1, a first signal Vg2 of a high level is applied to the second switching transistor T2. As a result, the second switching transistor T2 is turned on to connect the capacitor C to the power line P, so that the capacitor C is charged with the data signal. The driving transistor T4 is turned on by the data signal applied to the driving transistor T4 through the first switching transistor T1. The driving transistor T4 transmits a predetermined amount of electric current to the organic light emitting diode OLED, by controlling the amount of the electric current flowing through the power line P depending on the data signal applied thereto. That is, the organic light emitting diode OLED emits light by a data signal of a high level transmitted thereto.

Next, when the gate signal Vg1 enters a low level, the first switching transistor T1 is turned off, so that the data signal transmitted through the data line is no longer applied to the driving transistor T4. In this case, the data signal, with which the capacitor C has been charged, is applied to the driving transistor T4, so that the driving transistor T4 transmits the predetermined amount of electric current to the organic light emitting diode OLED although the first switching transistor T1 is turned off. That is, the organic light emitting diode OLED receives the data signal of the high level, thereby emitting light.

Thereafter, the first control signal Vg2 enters a low level a predetermined time interval before the gate signal Vg1 rises to the high level to initiate the next frame. That is, with the predetermined time interval before the first frame ends, the first control signal Vg2 sinks to the low level, and the second control signal Vg3 inverted from the first control signal Vg2 enters a high level. The second switching transistor T2 is turned off by the first control signal Vg2, and the third switching transistor T3 is turned on by the second control signal Vg3. Accordingly, the capacitor C is disconnected from the power line P and is connected to the ground terminal GND, so that the data signal, with which the capacitor C has been charged, flows out to the ground terminal GND. That is, the data signal, with which the capacitor C has been charged, is discharged to turn off the driving transistor T4, so that the electric current flowing through the power line P is not transmitted to the organic light emitting diode OLED. In other words, the data signal transmitted to the organic light emitting diode OLED sinks to a low level, so that the organic light emitting diode OLED does not emit light.

As described above, according to the organic electroluminescence display device of the embodiment of the present invention, since the capacitor is charged and discharged with a data signal by the switching transistors, there are periods during which the driving transistor is turned on and off. Therefore, it is possible to prevent the property of the driving transistor from being deteriorated, and there is a black pattern section in the driving transistor's turning-off period because the organic light emitting diode OLED2 does not emit light 12 in that period.

As described above, according to the embodiment of the present invention, the capacitor is charged and discharged with a data signal, so that it is possible to prevent the property of the driving transistor from being deteriorated and also to improve the image quality of the organic electroluminescence display device owing to the black pattern of the organic light emitting diode.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. An organic electroluminescence display device comprising:
a plurality of data lines for transmitting a data signal;
a plurality of gate lines intersecting the data lines and transmitting a gate signal;
a plurality of pixels formed by the data lines and the gate lines; and
a power line for transmitting power from an exterior, wherein,
each of the pixels comprising:
a first switching means having a first terminal connected to one of the data lines, a second terminal connected to one of the gate lines, and a third terminal through which the data signal is outputted;
a capacitor connected to the third terminal of the first switching means to be charged with the data signal;
a second switching means for connecting the capacitor to the power line;
a third switching means for connecting the capacitor to a ground terminal;
a driving means having a first terminal connected to the power line, a second terminal connected to the third terminal of the first switching means, and a third terminal through which electric current from the power line is outputted; and
an organic light emitting means connected to the third terminal of the driving means, the organic light emitting means emitting light, intensity of the light being proportional to amount of the electric current outputted through the third terminal of the driving means.

2. The organic electroluminescence display device as claimed in claim 1, wherein the first switching means is turned on/off by the gate signal, and the second and the third switching means are turned on/off by a first and a second control signal.

3. The organic electroluminescence display device as claimed in claim 2, wherein the second switching means is turned on at a time point when the first switching means is turned on to initiate a first frame, and is turned off a predetermined time interval before the first frame ends.

4. The organic electroluminescence display device as claimed in claim 3, wherein the third switching means is turned on at a time point when the second switching means is turned off, and is turned off at a time point when the first frame ends.

5. The organic electroluminescence display device as claimed in claim 1, wherein the capacitor is charged with the data signal during a period in which the second switching means is turned on, and is discharged with the data signal during a period in which the third switching means is turned on.

6. The organic electroluminescence display device as claimed in claim 5, wherein the driving means controls an amount of the electric current transmitted to the organic light emitting means, according to the data signal with which the capacitor is charged.

7. The organic electroluminescence display device as claimed in claim 6, wherein the driving means is turned off at a period when the third switching means is turn on.
